(19) United States
(12) Patent Application Publication
(10) Pub. No.: US 2007/0286197 A1
(43) Pub. Date: Dec. 13, 2007

(54) INTEROPERABLE TRANSPORT PROTOCOL FOR INTERNETWORK ROUTING

(76) Inventor: JOHN A. HARPER, Mountain View, CA (US)

Correspondence Address: MICHAEL W. CALDWELL, 4226 RIVERMARK PARKWAY, SANTA CLARA, CA, 95054-4150, US

(21) Appl. No.: 11/739,093

(22) Filed: Apr. 23, 2007

Related U.S. Application Data
(60) Provisional application No. 60/793,948, filed on Apr. 21, 2006.

(51) Int. Cl. H04L 12/56; H04L 12/18; H04L 12/28

(52) U.S. Cl. 370/392; 370/401

(57) ABSTRACT

In a communications network comprising a plurality of routers the routers exchange router control information by transmitting and receiving control messages. A method is disclosed for transmitting, receiving, acknowledging, and verifying receipt of the message or messages between at least two routers. A transmitting router maintains a list of unacknowledged messages and periodically retransmits all unacknowledged or incompletely acknowledged messages. A receiving router insures that a received message is not a duplicate and is not out of sequence before transmitting an acknowledgement message. The disclosed method may be compatible with other router control message protocols, providing interoperability.

### CROSS REFERENCE TO RELATED APPLICATIONS

The present application claims priority of U.S. Provisional Application Ser. No. 60/793,948 entitled “RELIABLE AND INTEROPERABLE TRANSPORT PROTOCOL FOR INTERNETWORK ROUTING”, filed on 21 APR. 2006, by John A. Harper, the application incorporated herein by reference in its entirety.

### BACKGROUND

Packet networks typically comprise multiple specialized routers, interconnected by wired and/or wireless media. Examples of networks so formed are Local Area Networks (“LAN”, Asynchronous Transfer Mode (“ATM” networks, and Frame Relay networks. Two or more computers, referred to as “hosts”, are connected to one or more of the routers. A router selects the best available path between any pair of hosts and forwards a data packet from one host to another using the selected path.

To determine the best available path, a router continually exchanges informational messages with other routers within the network about the state of the network connecting the routers. Each router uses a routing algorithm to compute the best path. The combination of the informational messages, the rules that determine their sending and processing upon receipt, and the way they are used to compute paths, is termed a “routing protocol”. Several routing protocols are currently in widespread use. Some of them have been made the subject of accepted standards, for example OSPF (“Open Shortest Path First”), standardized by the Internet Engineering Task Force (IETF). Others have been defined by suppliers of network equipment but have not been the subject of formal standardization and remain proprietary.

Routing protocols depend upon information transmitted between routers being reliable. Because a link that comprises a network may corrupt a transmitted message or an acknowledgement of a message, routing protocols typically contain mechanisms to ensure that a message has been received by resending the message if it is not verified that the message was received.

Two main classes of network routing protocols are in general use. They are referred to in the literature as “Distance Vector Routing Protocols” and “Link State Routing Protocols”. A description of these two techniques is presented in “Interconnections: Bridges, Routers, Switches and Internetworking Protocols, Second Edition”, ISBN-10: 0-201-63448-1, by Radia Perlman, published by Addison Wesley Professional, Sep. 14, 1999.

In a network operating in accordance with the Distance Vector Routing Protocol, each router in the network receives messages from all other associated routers describing each router's view of the network as a whole. The messages indicate the cost, using a suitable metric, of reaching each reachable host or collection of hosts from the corresponding router. A given router selects the lowest cost path of all paths described to it by the other routers in the network, and in turn transmits to the other routers the given router's best path cost to each host or collection of hosts. This process continues until all routers agree on the best set of paths. The process may be repeated whenever anything changes, such as a link in the network becoming available or unavailable. The present invention may be used in conjunction with such a protocol.

A frequently used Distance Vector Routing Protocol is denominated “EIGRP” (Enhanced Interior Gateway Routing Protocol), described in “EIGRP Network Design Solutions”, ISBN-10: 1-57870-165-1, by I. Pepelnjak, published by Cisco Press. EIGRP is related to a protocol denominated “IGRP” (Interior Gateway Routing Protocol), described in U.S. Pat. No. 5,088,032. EIGRP requires extensive communication between the routers comprising a network, and optimizes such communication using the innate multicast capabilities of a Local Area Network (LAN), where available. A given router transmits a single message to be received by all routers connected to the same LAN. Each connected router sends back an acknowledgement.

U.S. Pat. No. 5,519,704 describes a certain transport protocol for communicating routing information between routers, the protocol used as part of EIGRP when operating over a LAN. According to the disclosed protocol, a router takes advantage of the multicast capability of a LAN by sending a single message to all other routers (a multicast message). If a given router does not receive a verification message from all other routers the given router retransmits the message, but only to the router or routers from which no such verification message was received. Meanwhile, further messages are sent to other routers from which verification was received while the recovery (retransmission) is in progress, which contributes towards more rapid agreement amongst the routers as to the best paths to be used (a condition termed “convergence”. U.S. Pat. No. 5,519,704 discloses a routing method for use in conjunction with a routing method denominated “DUAL” (Diffusing Update ALgorithm), described in “Loop-Free Routing using Diffusing Computations” J. J. Garcia-Luna-Aceves, Network Information Systems Center, SRI International, IEEE/ACM Transactions on Networking (TON) Volume 1, Issue 1 (February 1993), pages 130-141, ISSN:1063-6692.

### SUMMARY

In a computer network, for example a LAN comprising a plurality of routers, the routing protocol requires frequent messages to be sent reliably from any given router to all other known routers. A message comprises a header and data. The header comprises a source address, a destination address, and a message sequence number. The destination address may allow a form of address termed “multicast address”, wherein a multicast address signifies that the (single) message is addressed to all connected routers. The data is termed the message “payload”. The payload data is arbitrary; it has no significance to the operation of the present invention.

Each router connected to a network will have been previously provided identity (address) information for all other routers operably connected to the network, a procedure outside of the present invention, but assumed to be in place. When a router sends a message, the router starts a timer, then waits for each other operably connected router to acknowledge the message. If an acknowledgement is received from each addressed router, the message is deemed to have been correctly received by all routers. If the timer expires and any connected router has not acknowledged the message, the router retransmits the message. The sending router keeps track of which routers have an unacknowledged message or messages. Until all routers have acknowledged a given message, the message is retransmitted periodically.

### BRIEF DESCRIPTION OF THE DRAWINGS

FIG. 1 is an example of a computer network comprising a plurality of routers. PRIOR ART

FIG. 2 is an example of a structure for a routing control message according to the present invention.

FIG. 3 is a flow chart of an example logical flow for sending a routing control message according to the present invention.

FIG. 4 is a flow chart of another example logical flow for sending a routing control message according to the present invention.

FIG. 5 is a flow chart of an example logical flow for a router to respond to a received routing control message according to the present invention.

FIG. 6 is a flow chart of an example logical flow for a router to respond to an acknowledgement message received from another router according to the present invention.

### DESCRIPTION OF SOME EMBODIMENTS

The present invention provides a communications protocol which provides reliability as well as interoperability with other protocols. For the purpose of discussion, this disclosure discloses the present invention in the context of a local area network (LAN), though any other network protocol providing an actual or simulated broadcast or multicast capability may also be used.

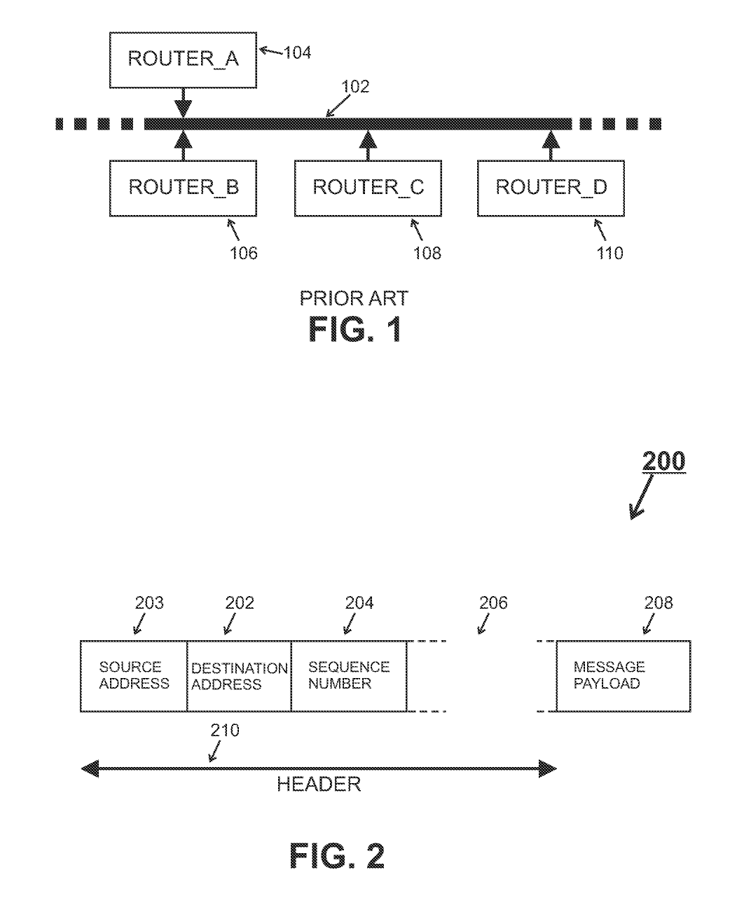

In FIG. 1, an example computer network comprises a plurality of routers: Router_A 104, Router_B 106, Router_C 108 and Router_D 110, all of the routers connected by a LAN 102. The operation of the routing protocol requires frequent messages be sent reliably from any one of the routers to any one or all of the other routers. A router, operating according to a distance-vector routing protocol such as EIGRP, may determine that it needs to reliably send a routing update message when: it receives an update from another router which causes it to change its own choice of path to another router or host; there is a change in the status of one of its own links, causing a change in choice of path; or a management operation, such as enabling or disabling a link or changing associated administrative parameters, resulting in a change in choice of path.

FIG. 2 shows the general form of a message 200 according to the present invention. A router creates a message 200 and transmits it on all appropriate links. Which link or links are appropriate is determined in accordance with the particular routing protocol being employed. The message 200 includes a header 210 comprising at least a source address field 203, a destination address field 202, and a sequence number field 204. The source address allows recipients of the message 200 to know from which router the message was transmitted, as well as the address for sending the acknowledgement message. The destination address 202 is how the underlying network is able to determine the identity (address) of each intended recipient for the message 200. According to the present invention the destination address 202 is normally an address signifying a multicast address. A multicast address causes the message to be provided to all routers attached to network 102. The sequence number (or “message number” 204 in combination with the source address allows individual messages to be uniquely identified. The address fields 203, 204 are typically thirty-two bit numbers, though other field sizes may be used as well. The range of the sequence number is large enough, for example thirty-two bits, such that there is no risk of an old message being confused with a new one. In some embodiments a particular protocol adds other optional fields 206. The meaning of the update message 200 is the “message payload” 208.

Under normal circumstances, a message will be received at all addressed routers. Each router sends an acknowledgement message back to the sender of the message, in the form shown in FIG. 2, wherein the destination address 202 of the acknowledgement message is the address of the message originating router, the source address 203 is the address of the acknowledging router, and the message sequence number 208 is the same as that of the received message. The acknowledgement message is delivered only to the router originating the control message.

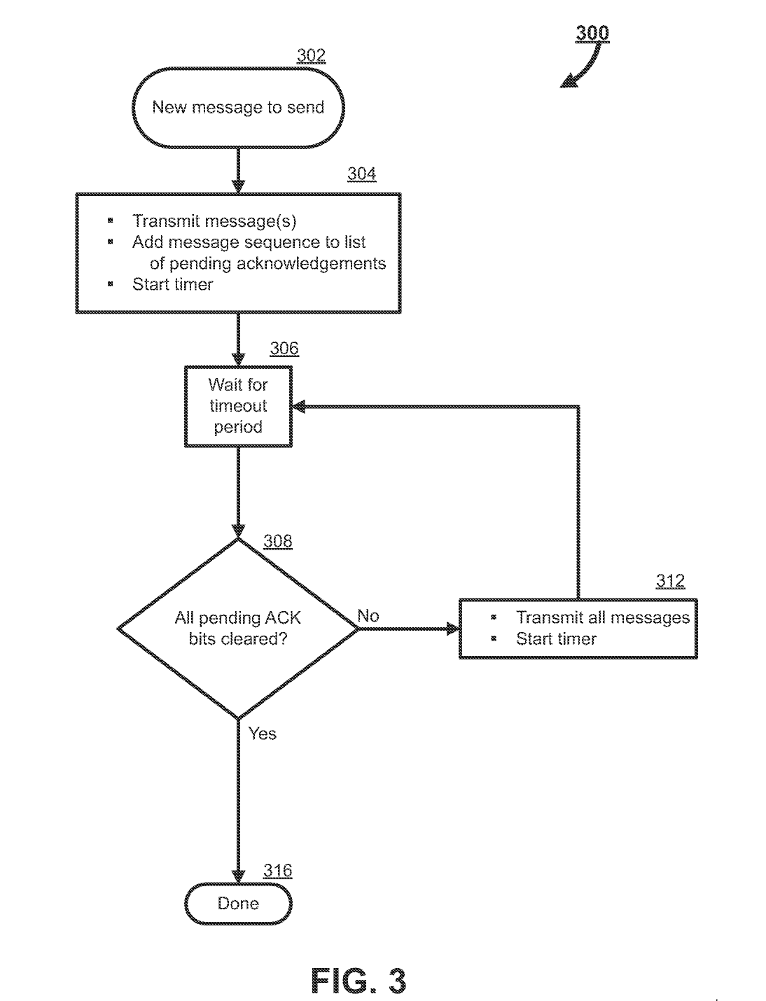

By way of example, consider the case of a message 200, for example a router control message sent from Router_A 104, understanding that the same method applies for messages sent from any given router to all other routers connected to a network, for example the LAN 102. Having assembled a complete message as shown in FIG. 2, Router_A 104 sends the message 200 via the network 102. FIG. 3 details logic flow 300, an example of a procedure wherein a router sends messages and insures the proper receipt of all messages by all routers connected to the network 102. At step 302 Router_A 104 decides to send a message and determines that the message is ready to be sent. At step 304 Router_A 104 transmits the message 200, adds the message sequence number to a list of pending message acknowledgements, then starts a delay timer. The timer may be a physical timer embodied into the design of a router or a software timer in a router's firmware. In one embodiment the router receives a continuous time signal from the network 102 and determines at what time signal value the router “times out” the waiting period. The timer delay is long enough for the message 200 to be transmitted to the other routers, processed by each receiving router, an acknowledgement returned by each addressed router, and the acknowledgement(s) processed by the sending router. Typically, the timer duration is a small number of seconds.

In some embodiments each message 200 has a timer value associated with the specific message 200; the timers are independent of each other. In one embodiment there is one timer per router. The timer is restarted when a message is sent. New messages may be allowed while a timer from a previous message is running, in which case the timer is restarted with each new message and the time delay for the oldest message may exceed one usual time out period. In other embodiments the timer is not restarted until it has expired normally, in which case a new message sent after a previous message was sent will be examined in less than a normal time delay period. In either embodiment using a single timer, once a timer has expired and no new messages are sent, the timer delay times are uniform. In the example presented we will assume there is a single timer for each router, the timer is restarted upon sending a new message, and all pending messages are checked with each timer time out event.

According to the flow 300, Router_A 104 waits at step 306 for the timer to expire. When the timer expires at step 306, Router_A 104 checks to see if all connected routers have acknowledged all messages at step 308. In one embodiment, router firmware uses flag bits in a table to signify the status of acknowledgements from the addressed routers. For the purpose of discussion we assume a table wherein a status bit is set (TRUE) if an acknowledgement (“ACK” is pending and the status bit is cleared (FALSE) if an acknowledgement is not pending; that is, an acknowledgement has been received.

TABLE 1

| Message | Router_B | Router_C | Router_D | |
|---|---|---|---|---|
| Sequence No. | Pending | Pending | Pending | Notes |
| 1234 | 0 | 0 | 0 | Packet received by each router; |
| | | | | delete from table |
| 1235 | 1 | 0 | 0 | Packet partially received; retain for |
| | | | | possible retransmission |
| 1236 | 1 | 1 | 1 | New packet; not yet acknowledged |
| | | | | by any router |

Table 1 is an example of one embodiment wherein a table is used by Router_A 104 to record which messages have been sent and acknowledged by-router, for example Router_B 106, Router_C 108 and Router_C 110. In the example of Table 1 a signifying word is formed by combining the message sequence number with flag bits, wherein there is a flag bit field corresponding to each addressed router. As the number of connected routers within network 102 changes, the number of flag bits changes correspondingly. A message is not deemed to be acknowledged unless all of the flag bits in the word have been cleared.

In another embodiment, for example according to Table 2, a signifying word is formed by combining a message sequence number 208 with the address 202 of an addressed router plus a status bit; one word per message/router combination. When the flag bit of a table entry word is cleared the corresponding signifying word may be removed from the table. A message is deemed to have been acknowledged when all table entries with a common message sequence number have had their flag bit cleared. Note that Table 2 represents the same status set as that of Table 2. For the purpose of illustration, Router_B is at address 2; Router_C is at address 3; and Router_D is at address 4.

TABLE 2

| Message | Router | |
|---|---|---|
| Sequence No | Address | Status Flag |
| 1234 | 2 | 0 |
| 1234 | 3 | 0 |
| 1234 | 4 | 0 |
| 1235 | 2 | 1 |
| 1235 | 3 | 0 |
| 1235 | 4 | 0 |
| 1236 | 2 | 1 |
| 1236 | 3 | 1 |
| 1236 | 4 | 1 |

Continuing with the example, assume that the timer that expires at step 306 corresponds to the most recent message, message number 1236. Looking at Table 1 or Table 2, we see that message number 1236 and message number 1235 have not yet been acknowledged by at least one of the addressed routers. So from step 308 we move to step 312 to transmit all messages pending acknowledgement, restart the timer, and branch to step 306. Message number 1234 has been acknowledged by all addressed routers, so message 1234 is not retransmitted. In some embodiments the logic of receiving acknowledgements, for example flow 600, removes table entries when a message has been acknowledged by all routers, so at step 308 only pending messages, if any, are seen. In some embodiments flow 600 updates pending ACK bits, but does not remove any messages from the table of pending ACK bits. In that case step 308 further includes removal from the table, for example Table 1 or Table 2, messages with no pending ACK bits TRUE.

Now assume that the next time the timer expires at step 306 all pending bits have been cleared for message 1235 and message 1236. Thus we jump to step 316 and exit the flow 300. If the timer is a free running timer it may be stopped at step 316. In some embodiments the timer does not automatically restart, so nothing more be done at step 316.

An additional failure mechanism that must be accounted for is the case wherein a message is successfully received by a router, for example message number 1235 to Router_B 106, at the time of the first transmission of message 1235 by Router_A 104, but the acknowledgement from Router_B 106 back to Router_A 104 is lost or corrupted. Router_A 104, without knowledge that Router_B 106 actually received message 1235, will retransmit message 1235, but Router_B 106, seeing it as a duplicate message, will not send back an acknowledgement. Because of this, Router_A 104 will continue to retransmit the message 1235 each time the timer expires. Eventually another message will need to be sent, for example message 1236. When Router_B 106 receives message 1236 for the first time it will send an acknowledgement for message 1236 back to Router_A 104. Router_A 104 treats an acknowledgement of a later message, in this example message 1236, as also indicating correct receipt by Router_B 106 of all earlier messages and will therefore clear the status bits of all earlier messages pending for Router_B 106. In one embodiment (not shown) wherein no new messages have been sent and a previously sent message has gone unacknowledged by at least one router for a predetermined number of timer expiration events, for example ten events, the sending router, such as Router_A 104 in the example, will send a copy of the overdue message using a new message number as an attempt to clear the unacknowledged message, assuming that the persistent pending status is due to an acknowledgement message having been corrupted.

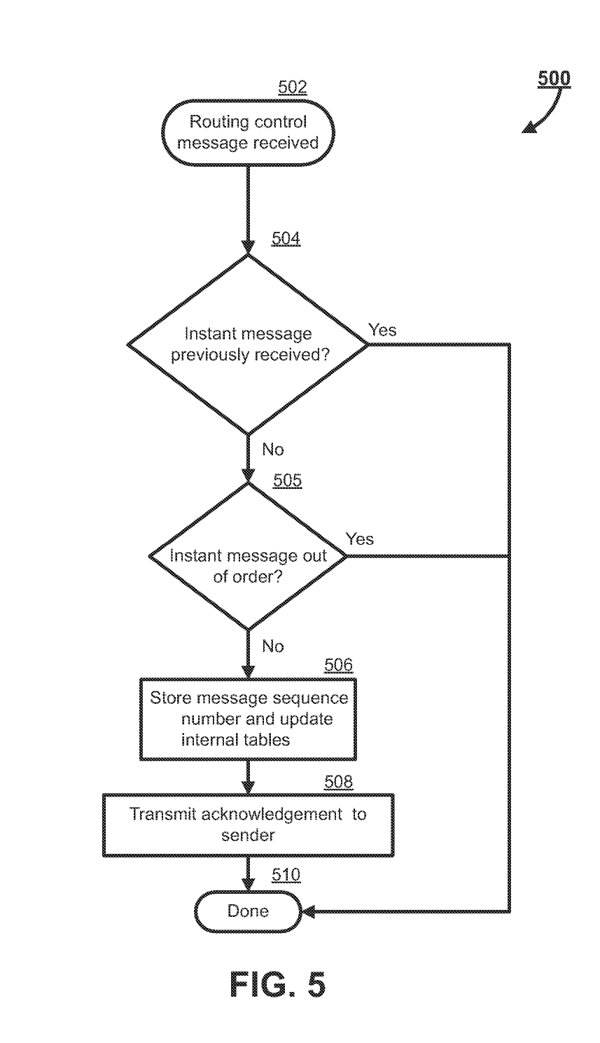

It is possible, though unlikely, that several messages may be lost. To be sure that each message is correctly received, Router_A 104 keeps track of all messages which have not yet been acknowledged by all connected routers, for example by using a table like that of Table 1, and periodically retransmits each of them. In some embodiments the messages are retransmitted in their original order. Messages may be sent asynchronously. That is, the timer may be pending for a certain message (waiting for all acknowledgements to the certain message) and the router determines that another, newer message should be sent. The newer message may be sent during the timer pending period of the certain message. In this case, a router may receive a later message before it has received an earlier message. For example, suppose that a second message 1236 is sent before the timer for message 1235 expires. If Router_B 106 successfully receives message 1236 before message 1235 (that is, for this example, message 1235 was corrupted during transmission to Router_B 106) Router_B 106 will ignore message 1236 (see flow 500, FIG. 5, step 505) because a router will ignore any message which is received out of sequence. Therefore Router_A 104 does not receive an acknowledgement to message 1236 from Router_B 106 and messages 1235 and 1236 will be retransmitted when the timer for message 1236 expires. As a result, message 1236 will eventually be received by Router_B 106 after Router_B 106 has received and acknowledged message 1235, at which time Router_B will acknowledge the next successful receipt of message 1236.

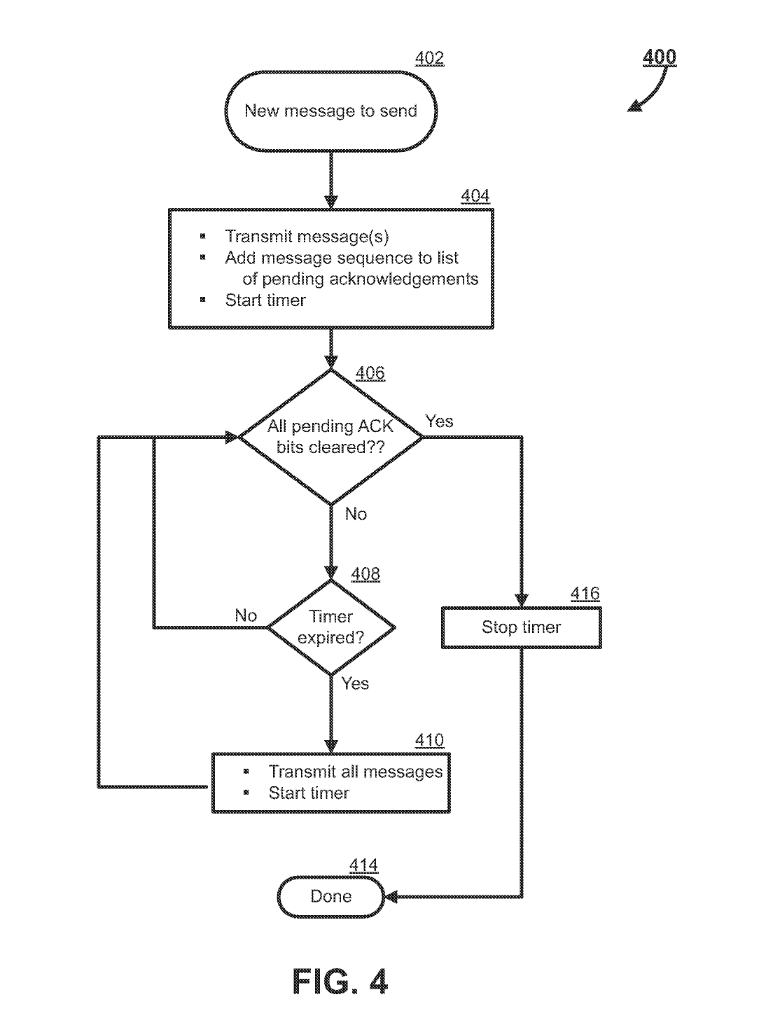

FIG. 4 is an example of another logical flow 400. Similar to steps 302 and 304, at step 402 Router_A 104 determines a message should be sent and that the message 200 is ready. At step 404 message 200 is sent, the message signifier added to the list of pending acknowledgements, and a timer is started. At step 406, Router_A 104 checks to see if all pending bits, for example as in Table 1 or Table 2, are cleared. If all pending bits have been cleared step 416 is taken, wherein the timer is stopped, and the flow 400 is then completed at step 414. No further action is taken until a new message is started, step 402. If at step 406 there are any pending bits (Table 1, Table 2) not cleared, the timer is checked for expiration at step 408. If the timer has not expired the flow returns to step 406 to once again check for all acknowledgement pending bits to be cleared. If, however, the timer has expired at step 408, step 410 is taken. At step 410 all messages remaining on the pending list are retransmitted, the timer restarted, and the flow branches back to step 406.

FIG. 5 is an example of a flow 500 describing the actions taken at a router in response to a received message 200. A router, for example Router_B 106, recognizes that a message has been received at step 502. At step 504 the router checks to see if the instant message has been previously received. If the instant message, which will be known by its message sequence number, has been previously received, Router_B 106 branches to step 510; that is, nothing is done in response to receipt of the message. If the message has not been previously received by Router_B 106 we branch to step 505 to determine, based upon message sequence number, if the instant message is out of sequence; that is, if the sequence number of the instant message is not the next sequence number in order from the last-received message. For example, if the last message number received by Router_B 106 is message number 1234 and the instant message is message number 1236, the test at step 505 is TRUE and the logic branches to step 510, essentially ignoring message 1236 (until message 1235 is received at a later time).

If the instant message 200 has not been previously received and is in the proper sequence it is stored at step 506 and internal data, for example a table listing the message numbers of previously received messages, is updated. Router_B 106 will decode the message payload 208 and respond according to the payload and the command structure of the network 102, which is beyond the scope of the present invention. At a minimum the table maintained by a receiving router is the message number of the last properly received message.

When a new message 200 is received and the appropriate data stored at step 506, at step 508 a router sends an acknowledgement message 200, of a form consistent with the structure shown in FIG. 2, back to the sending router. That is, continuing with the example, Router_B 106 forms a message where the destination address 202 is the address of Router_A 104, the source address 203 is the address of itself (Router_B 106), and the message sequence number 204 is the same as the message sequence number of the message received from Router_A 104. When the acknowledgement message has been sent (step 508), the logic branches to step 510 and exits.

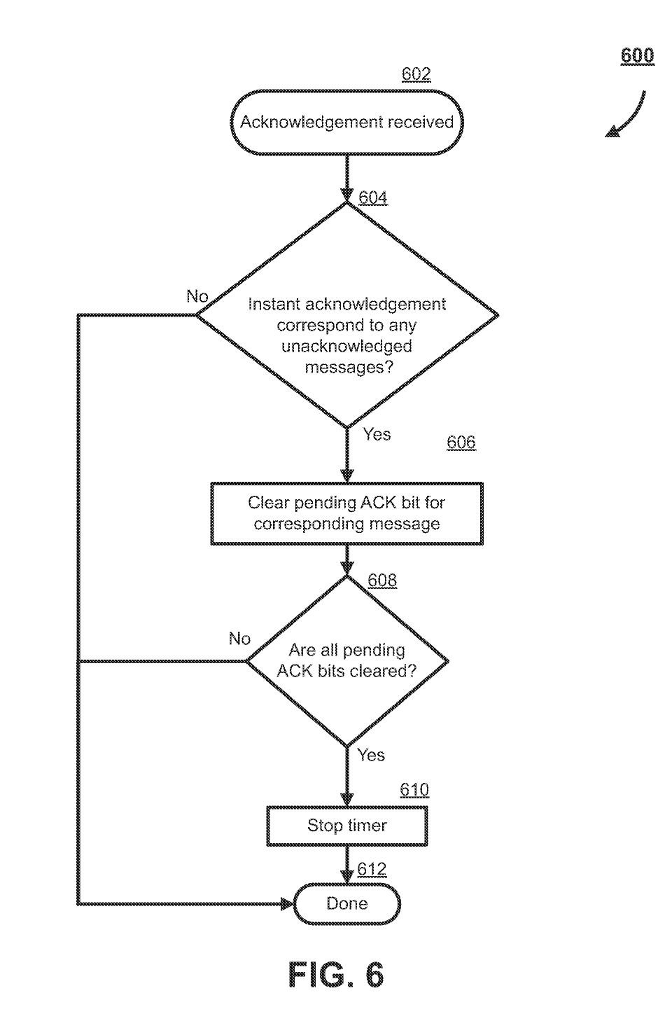

FIG. 6 is an example of a logical flow 600 wherein a received acknowledgement is processed. At step 602 the acknowledgement message 200 is received from another router. In the case of the presented example, a message 200 from Router_B 106, Rounter_C 108 or Router_D 110 is received by Router_A 104. At step 604 Router_A 104 looks to see if the acknowledgement is expected; that is, if the router and message sequence number correspond to any open table entries, for example as discussed in reference to Table 1 or Table 2. If not, the acknowledgement is ignore by branching to step 612 to exit. If the acknowledgement is expected, at step 606 Router_A 104 clears the acknowledgement pending bit in Table 1 or Table 2 corresponding to the router address of the router which sent the instant message (as found in the massage 200 source address 203) and message sequence number 204. Next, at step 608, Rounter_A 104 checks to see if all pending acknowledgement bits have been cleared. If the test at step 608 is TRUE, the timer is stopped at step 610, and the flow 600 exits at step 612. In some embodiments step 610 further includes removing the table entry of all messages which have no pending bits set. If there are still pending acknowledgement bits, that is the test at step 608 is FALSE, step 608 branches directly to step 612, effectively leaving the timer running. Flow 600, then, is asynchronous, running only upon receipt of an acknowledgement message.

It will be evident to one skilled in the art that this mechanism applies to an indefinitely large number of routers attached to the same network 102. Extra storage is required to keep track of the acknowledgement status of each message, but the above procedure applies without modification.

U.S. Pat. No. 5,519,704 describes a procedure wherein routers are informed explicitly that certain messages are subject to “conditional receipt”. Such messages are explicitly marked, and only routers which have been informed by the sender are permitted to receive them. In the present invention a router, for example Router_B 106, which receives a message marked for conditional receipt simply ignores it. It also ignores the Sequence TLV which designate which routers are permitted to receive such packets. Under these circumstances, the sending router will initiate error recovery by unconditionally unicasting a retransmission of the message (that is, addressed only to Router_B 106), as described in detail in U.S. Pat. No. 5,519,704. A router operating in accordance with the present invention will, upon receipt of the unicast message, acknowledge its receipt, causing the sending router to stop retransmission, thereby providing interoperability with other routers connected to LAN 102 that are operating per the procedure documented in aforementioned U.S. Pat. No. 5,519,704.

The foregoing description of preferred embodiments of the invention has been presented for the purposes of illustration and description. The description is not intended to be exhaustive or to limit the invention to the precise forms disclosed. Many modifications and variations will be apparent to one skilled in the relevant art.

Reservation of Extra-Patent Rights, Resolution of Conflicts, and Interpretation of Terms

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

Given the above disclosure of general concepts and specific embodiments, the scope of protection sought is to be defined by the claims appended hereto. The issued claims are not to be taken as limiting Applicant's right to claims disclosed, but not yet literally claimed subject matter by way of one or more further applications including those filed pursuant to 35 U.S.C. §120 and/or 35 U.S.C. §251.

Unless expressly stated otherwise herein, ordinary terms have their corresponding ordinary meanings within the respective contexts of their presentations, and ordinary terms of art have their corresponding regular meanings

What is claimed is:

1. In a network comprising a plurality of connected routers wherein each router has a unique corresponding address and each router has the address of at least one other router connected to the network, a method for transmitting a router control message from a given one of the plurality of routers to each router in the network for which the given one router has an address, comprising the steps of:
(a) transmitting a message, the message comprising:
a source address corresponding to the given one router;
a destination address wherein the destination address is a multicast address;
a message sequence number; and
a message payload;
(b) adding a signifying word corresponding to the message to a list of signifying words;
(c) starting a timer for timing a delay period; and
(d) in response to completion of the delay period:
(1) examining the list of signifying words and if the list is not empty:
retransmitting all messages referenced by the list
restarting the timer; and
continuing the method from step d).

2. The method according to claim 1, further including a step immediately prior to step (d)(1) comprising: examining the list of signifying words and removing from said list each signifying word corresponding to a message sequence number that has been acknowledged by all addressed routers.

3. The method according to claim 1, wherein the signifying word is formed by combining the message sequence number with a representation of the destination address.

4. In a network comprising a plurality of connected routers wherein each router has a unique corresponding address and each router has the address of at least one other router connected to the network, a method for transmitting a router control message from a given one of the plurality of routers to each router in the network for which the given one router has an address, comprising the steps of:
(a) transmitting a message, the message comprising:
a source address corresponding to the given one router;
a destination address wherein the destination address is a multicast address;
a message sequence number; and
a message payload;
(b) adding a signifying word corresponding to the message to a list of signifying words;
(c) starting a timer for timing a delay period;
(d) examining the list of signifying words and if the list is empty stopping the timer; and else
(e) determining if the delay period has completed, and if the delay period has not completed, continuing the method from step (d); and else
retransmitting all messages referenced by the list;
restarting the timer; and
continuing the method from step d).

5. The method according to claim 4, wherein step (d) further includes a step at the beginning of step (d) comprising: examining the list of signifying words and removing from said list each signifying word corresponding to a message sequence number that has been acknowledged by all addressed routers.

6. The method according to claim 4, wherein the signifying word is formed by combining the message sequence number with a representation of the destination address.

7. In a network comprising a plurality of connected routers wherein each router has a unique corresponding address and each router has the address of at least one other router connected to the network, a method for receiving a router control message from a given one of the plurality of routers by a router in the network wherein said message comprises: a source address corresponding to the given one router; a destination address wherein the destination address is a multicast address; a message sequence number; and a message payload, the method comprising the steps of:
(a) comparing the message sequence number to a list of received messages and if the message sequence number is found on the list making no response; else
(b) comparing the message sequence number to a list of received messages and if the message is not valid according to a rule making no response; and else
(c) adding the message number to the list of received messages; and
(d) transmitting a message to the given one of a plurality of routers, the message comprising:
a source address corresponding to the router sending the instant message;
a destination address corresponding to the address of the given router; and
the message sequence number.

8. The method according to claim 7, wherein the rule requires that the message sequence number be a numerical one greater than the numerically highest message sequence number on the list.

9. In a network comprising a plurality of connected routers wherein each router has a unique corresponding address and each router has the address of at least one other router connected to the network and wherein a given one of the plurality of routers has transmitted a message to each router in the network for which the given one router has an address; a method for receiving an acknowledgement message from a router in the network wherein said message comprises: a source address corresponding to the router; a destination address corresponding to the given one router; and a message sequence number, the method comprising the steps of:
(a) comparing a signifying word corresponding to the message to a list of signifying words and if the signifying word is not found on the list taking no action; and else
(b) updating the list of signifying words; and
(c) examining the list of signifying words and if the list is not empty stopping a delay timer.

10. The method according to claim 9, wherein the signifying word is formed by combining the source address with the message sequence number.
